(19) United States
(12) Patent Application Publication
(10) Pub. No.: US 2005/0287336 A1
(43) Pub. Date: Dec. 29, 2005

(54) Carpet coating compositions

(76) Inventors: David J. Lunsford, Simpsonville, SC (US); Rajeev Farwaha, Belle Mead, NJ (US); James Walker, Whitehouse Station, NJ (US)

Correspondence Address: FERRELLS, PLLC, P. O. BOX 312, CLIFTON, VA, 20124-1706, US

(21) Appl. No.: 10/875,849

(22) Filed: Jun. 24, 2004

(51) Int. Cl. B32B 33/00

(52) U.S. Cl. 428/97; 428/95

(57) ABSTRACT

The invention is directed to carpet coating compositions which utilize an emulsion binder which is prepared by emulsion polymerization of ethylene, a vinyl ester monomer and a functional monomer and to carpet products prepared with the carpet coating compositions.

### FIELD OF THE INVENTION

The present invention relates to carpet coating compositions which contain an ethylene/vinyl ester-based emulsion binder and which exhibit improved adhesion to polyvinylbutyral substrates.

### BACKGROUND OF THE INVENTION

Most conventional carpets comprise a primary backing with yarn tufts in the form of cut or uncut loops extending upwardly from the backing to form a pile surface. In the case of tufted carpets, the yarn is inserted into a primary backing by tufting needles and a pre-coat or binder is applied thereto. In the case of non-tufted or bonded pile carpets, the fibers are embedded and actually held in place by the binder composition.

In both cases, the carpet construction usually also includes a secondary backing bonded to the primary backing. The secondary backing provides extra padding to the carpet, absorbs noise, adds dimensional stability and often functions as a heat insulator. The secondary backing is laminated to the primary backing by a binder composition or by an adhesive layer applied to the tuft-lock coated primary backing. Similar techniques are used in the preparation of carpet tiles and continuous roll goods. One of the most common types of secondary backings is made from polyvinylchloride (“PVC”). The PVC is applied to the back of the carpet either as a liquid plastisol (which is then cured) or as a preformed sheet which is heat laminated to the back of the carpet. Ethylene vinylacetate based emulsions have been used as the main precoat binder for PVC backed carpet due to their excellent adhesion properties to PVC. Carpet manufacturers have been looking for alternate materials to replace PVC and polyvinylbutyral (“PVB”) has been identified as a possible candidate as it a halogen free material. The use of PVB places a further requirement on the binder utilized in the primary coating (also called the precoat) that it provide good adhesion to the PVB secondary backing. Thus, the physical properties of the binder are important to successful utilization as a carpet backing coating for the present invention. In this regard, there are a number of important requirements which must be met by such a coating. It must be capable of being applied to the carpet and dried using the processes and equipment conventionally employed in the carpet industry for latex, e.g. emulsion, coating. It must provide excellent adhesion to the pile fibers to secure them firmly to the backing, both in tufted and non-tufted constructions. The coating also must have low smoke density values and high flame retardant properties and must accept fillers such as calcium carbonate, clay, aluminum trihydrate, barite and feldspar. Furthermore, the coating must maintain sufficient softness and flexibility, even with high filler loading or at low temperature, to enable the carpet, if prepared in continuous form, to be easily rolled and unrolled during installation. The softness and flexibility properties then will vary depending on the style of carpet but, in all cases, it is important that the carpet tile will lie flat and not exhibit a tendency to curl or dome.

It would be desirable to provide a coating composition for use in the manufacture of carpets and carpet tiles, wherein the coating composition exhibits superior adhesion to PVB. Further, the coating compositions must be able to accept and permanently adhere to a secondary backing such as PVB, hot melt adhesive, woven fabric, a foam or solid film or another backing compositions.

### SUMMARY OF THE INVENTION

The present invention is directed to carpet coating compositions which comprise an emulsion binder which contains an interpolymer prepared by emulsion polymerization of ethylene, a vinyl ester monomer which is copolymerizable with ethylene and from about 1 pphm (parts by weight per hundred parts by weight of monomer used to prepare the interpolymer) to 10 pphm, of a functional monomer. The emulsion binder is stabilized with a combination of a protective colloid (such as polyvinyl alcohol) and a surfactant package. The coating composition also may comprise ingredients selected from the group consisting of filler, thickener, frothing agent, and dispersant, in amounts effective to perform their respective intended functions. The invention also is directed to articles of manufacture, namely carpet products, which have applied thereto an amount of the coating composition effective to provide sufficient adhesion to PVB substrates.

### DETAILED DESCRIPTION OF THE INVENTION

The coating composition of the invention comprises an emulsion binder which is prepared by emulsion polymerization of from about 20 pphm to about 40 pphm of ethylene, from about 60 pphm to about 80 pphm of a vinyl ester monomer, from about 1 pphm to 10 pphm of an functional monomer, from about 2 to about 5 pphm polyvinyl alcohol, from about 1 to about 4 pphm surfactant; and up to 5 pphm of optional comonomers, provided that the maximum amount of optional comonomer used must be effective to maintain sufficient adhesion of the coating composition to the PVB secondary backing.

We now have found that emulsion polymers prepared from ethylene, a vinyl ester monomer and the functional monomer provide superior binders for use in carpet backings, particularly for use in carpet backed with PVB. The emulsion binders may be formulated to prepare primary carpet coating compositions which contain 20 to 70 percent by weight of the emulsion binder and 80 to 30 percent by weight of filler, based on the total weight of the carpet coating composition.

The coating compositions of the present invention advantageously are utilized in the production of conventional tufted carpet, non-tufted carpet and needle-punched carpet and are dried using equipment which is readily available in most carpet mills. Thus, the coatings are useful in the production of pile carpets comprising a primary backing with pile yarns extending from the primary backing to form pile tufts; as well as non-tufted carpets wherein the fibers are embedded into a binder composition which has been coated onto a woven or non-woven substrate. In addition, the coating composition can be loaded with a filler, such as calcium carbonate, clay and aluminum trihydrate, which enhances the flame retardancy and low smoke properties of the carpet without adversely affecting the adhesive properties of the coating. For example, the coating may comprise from about 20 to 70 percent by weight of the emulsion binder composition and from about 80 to 30 percent by weight of aluminum trihydrate filler.

The present invention also provides a method of preparing a pile or tufted carpet which includes the steps of;
a) tufting or needling the yarn into a woven or non-woven backing;
b) applying the carpet coating of the present invention to the rear of the backing such that the yarn is embedded in the carpet coating; and
c) drying the resultant carpet construction.

In producing such tufted carpets it is also desirable to apply a secondary backing to the primary backing either before or after drying of the carpet coating, depending upon the type of backing employed.

Non-tufted carpets also may be prepared utilizing the carpet coating compositions of the invention by a method which comprises the steps of:
a) coating the composition of the present invention onto a substrate;
b) embedding the carpet fibers in the substrate; and
c) drying the resultant carpet construction.

These non-tufted carpets also may be advantageously prepared utilizing a secondary backing to provide additional dimensional stability.

The vinyl ester monomers utilized to prepare the emulsion binders herein are the esters of alkanoic acids, the acid having from one to about 13 carbon atoms. Vinyl acetate is the preferred monomer because of its ready availability and low cost. The vinyl ester is used in amounts of from about 60 pphm to about 80 pphm, preferably 70 pphm to 80 pphm.

The ethylene component generally is added at levels of from about 20 pphm to about 40 pphm, preferably from about 20 pphm to about 30 pphm.

A functional monomer is used in preparation of the emulsion binders. Exemplary functional monomers include acrylic and methacrylic acid or the half esters of maleic acid such as monoethyl, monobutyl or monooctyl maleate, beta carboxy ethyl acrylate, acrylamide, N,N-dimethyl acrylamide, hydroxy alkyl acrylate, hydroxy alkyl methacrylate, N-methylol (meth)acrylamide, N-vinylpyrrolidinone, N-vinyl formamide, and the like.

The emulsion polymer is stabilized with a combination of polyvinyl alcohol (hereinafter PVOH) and a surfactant package. While a combination of anionic and nonionic surfactant may be utilized, it is preferred that the surfactant be predominantly anionic.

Other optional comonomers, such as acrylates and maleates may also be included. Exemplary acrylate and maleate monomers include methyl acrylate, ethyl acrylate, butyl acrylate, 2-ethyl hexyl acrylate and the like.

It may also be desired to incorporate in the emulsion polymer minor amounts of one or more multi-functional comonomers. Suitable multi-functional comonomers include, for example, diallyl adipate, triallyl cyanurate, butanediol diacrylate, allyl methacrylate, and the like. The latter multifunctional comonomers generally are used at levels of less than 2.5 pphm, preferably less than 0.5 pphm, depending upon the nature of the specific multifunctional comonomer. Preferably, the emulsion binders are prepared without the use of such monomers.

In addition, certain copolymerizable monomers which assist in the stability of the emulsion binder, e.g., vinyl sulfonic acid, are also useful herein as emulsion stabilizers. These optionally present monomers, if employed, are added in very low amounts of from 0.1 pphm to about 2 pphm.

Preferably, the interpolymer has a Tg in the range of about 0 to about −40 C and is the emulsion polymerization product of from about 20 pphm to about 40 pphm of ethylene monomer, from about 60 pphm to about 80 pphm of the vinyl ester monomer and from about 1 pphm to 10 pphm of the functional monomer. More preferably, the emulsion polymer is prepared by emulsion polymerization of from about 20 pphm to about 30 pphm of ethylene, from about 70 pphm to about 80 pphm of vinyl acetate, from about 1 to about 7 pphm of the functional monomer, from about 2 to about 5 pphm PVOH, from about 1 to about 4 pphm surfactant and less than 5 pphm of the optional comonomer. Even more preferably, less than 2.5 pphm of optional comonomer are used in preparing the interpolymer.

Methods for preparing ethylene/vinyl acetate copolymer emulsions are well known in the art and any of the customary procedures, together with the incorporation of ethylene pressure, can be used such as those emulsion polymerization techniques described in such chemistry texts as POLYMER SYNTHESIS, Vol. 1 and 11, by Stanley R. Sandler and Wolf Karo, Academis Press, New York and London (1974), and PREPARATIVE METHODS OF POLYMER CHEMISTRY, second edition, by Wayne R. Sorenson and Tod W. Campbell, Interscience Publishers (John Wiley &Sons), New York (1968) and in U.S. Pat. No. 5,026,765.

A preferred method for preparing the ethylene/vinyl acetate-based emulsion of this invention having a solids content of from about 40 to about 75 weight percent involves the initial preparation of a seed emulsion. A premix comprising emulsifying agents and PVOH with surfactant initially is charged to a polymerization reactor, agitated and purged with nitrogen twice and then with ethylene. A required amount of vinyl acetate monomer is charged to the reactor for seed formation. The reactor then is pressurized with the requisite ethylene pressure to provide the EVA copolymer having the desired ethylene content. The reaction is redox polymerized. The pressurized ethylene source can be shut off from the reactor so that the ethylene pressure decays as it is polymerized, or it can be kept open to maintain the ethylene pressure throughout the reaction, i.e., make-up ethylene. At about 40° C., the pressure is equilibrated to a desired ethylene pressure.

After seed formation, the redox components and monomer slow-add are added over a period of time. At the end of reaction, the material (having free VA monomer of approximately 2-3%), is transferred to a stripper. Reducing/oxidizing agents then are added until the free monomer content is reduced to less than 1%, preferably less than 0.1%. The polymerization reaction medium is cooled and adjusted to a pH of about 4 to 6 to maintain a stable emulsion.

Suitable free radical polymerization catalysts are the catalysts known to promote emulsion polymerization and include water-soluble oxidizing agents, such as, organic peroxides (e.g., t-butyl hydroperoxide, cumene hydroperoxide, etc.), inorganic oxidizing agents (e.g., hydrogen peroxide, potassium persulfate, sodium persulfate, ammonium persulfate, etc.) and those catalysts that are activated in the water phase by a water-soluble reducing agent. Typical reducing agents such as ascorbic acid, erythorbic acid, sodium formaldehyde sulfoxylate, 2-hydroxy-2-sulfinatoacetate disodium salt etc. Such catalysts are employed in a catalytic amount sufficient to cause polymerization. As a general rule, a catalytic amount ranges from about 0.1 to 5 pphm.

The emulsifying agents are those generally used in emulsion polymerization. The emulsifiers can be anionic, cationic, surface-active compounds or mixtures thereof.

Suitable nonionic emulsifiers include polyoxyethylene condensates. Exemplary polyoxyethylene condensates which can be used include polyoxyethylene aliphatic ethers, such as polyoxyethylene lauryl ether and polyoxyethylene oleyl ether; polyoxyethylene alkaryl ethers, such as polyoxyethylene nonylphenol ether and polyoxyethylene octylphenol ether; polyoxyethylene esters of higher fatty acids, such as polyoxyethylene laurate and polyoxyethylene oleate, as well as condensates of ethylene oxide with resin acids and tall oil acids; polyoxyethylene amide and amine condensates such as N-polyoxyethylene lauramide, and N-lauryl-N-polyoxyethylene amine and the like; and polyoxyethylene thio-ethers such as polyoxyethylene n-dodecyl thio-ether.

Nonionic emulsifying agents which can be used also include a series of surface active agents available from BASF under the PLURONIC and TETRONIC trade names. PLURONIC® emulsifiers are ethylene oxide (EO)/Propylene oxide (PO)/ethylene oxide block copolymers which are prepared by the controlled addition of PO to the two hydroxyl groups of propylene glycol. EO is then added to sandwich this hydrophobe between two hydrophilic groups, controlled by length to constitute from 10% to 80% (w/w) of the final molecule. PLURONIC® R emulsifiers are PO/EO/PO block copolymers prepared by adding EO to ethylene glycol to provide a hydrophile of designated molecular weight. PO is then added to obtain hydrophobic blocks on the outside of the molecule. TETRONIC® emulsifiers are tetra-functional block copolymers derived from the sequential addition of PO and EO to ethylene-diamine. TETRONIC® emulsifiers are produced by the sequential addition of EO and PO to ethylene-diamine. In addition, a series of ethylene oxide adducts of acetyleneic glycols, sold commercially by Air Products under the SURFYNOL® trade name, are suitable as nonionic emulsifiers.

Representative anionic emulsifiers include the alkyl aryl sulfonates, alkali metal alkyl sulfates, the sulfonated alkyl esters, and fatty acid soaps. Specific examples include sodium dodecylbenzene sulfonate, sodium butyinaphthalene sulfonate, sodium lauryl sulfate, disodium dodecyl diphenyl ether disulfonate, N-octadecyl sulfosuccinate, disodium ethoxylated alcohol half ester of sulfosuccinic acid and dioctyl sodiumsulfosuccinate. The emulsifiers are employed in amounts effective to achieve adequate emulsification of the polymer in the aqueous phase and to provide desired particle size and particle size distribution. Other ingredients known in the art to be useful for various specific purposes in emulsion polymerization, such as, acids, salts, chain transfer agents, and chelating agents, also may be employed in the preparation of the polymer. For example, if the polymerizable constituents include a monoethylenically unsaturated carboxylic acid monomer, polymerization under acidic conditions (pH 2 to 7, preferably 2 to 5) is preferred. In such instances the aqueous medium can include those known weak acids and their salts that are commonly used to provide a buffered system at the desired pH range.

Various protective colloids may also be used in place of or in addition to the emulsifiers described above. Suitable colloids include PVOH, casein, hydroxyethyl cellulose, starch, carboxyxethyl cellulose, gum arabic, and the like, as known in the art of synthetic emulsion polymer technology. In general, these colloids are used at levels of 0.05 to 4% by weight based on the total emulsion.

The manner of combining the polymerization ingredients can be by various known monomer feed methods, such as, continuous monomer addition, incremental monomer addition, or addition in a single charge of the entire amounts of monomers. The entire amount of the aqueous medium with polymerization additives can be present in the polymerization vessel before introduction of the monomers, or alternatively, the aqueous medium, or a portion of it, can be added continuously or incrementally during the course of the polymerization.

Following polymerization, the solids content of the resulting aqueous heterogeneous polymer emulsion binder can be adjusted to the level desired by the addition of water or by the removal of water by distillation. Generally, the desired level of polymeric solids content is from about 40 weight percent to about 75 weight percent based on the total weight of the emulsion, more preferably from about 50 weight percent to about 70 weight percent.

If desired, conventional additives may be incorporated into the coating composition with the binder of our invention in order to modify the properties thereof. Among these additives may be included fillers, thickeners, dispersants, colorants, biocides, foaming agents, and the like.

In particular, the ability to load the coating composition with fillers such as clay, calcium carbonate, aluminum trihydrate, barium sulfate, feldspar, etc., permits improved flame retardancy, lowers smoke properties and reduces the cost of the coating composition. Preferred coating compositions in accordance with the present invention are loaded with filler to yield a composition comprising from about 20 to about 70 weight percent emulsion binder, and from about 80 to about 30 weight percent filler, based on total weight of the composition, depending in part on the type and form of the carpet being constructed.

In preparing a tufted carpet, the yarn is tufted or needled into a primary backing which is generally non-woven polypropylene, polyethylene or polyester or woven jute or polypropylene. If a secondary backing is used, it is generally formed of woven or non-woven materials similar to those used as the primary backing and applied directly to the wet pre-coated primary backing prior to the drying step or applied with a separator adhesive to the dried pre-coated primary backing. Such a secondary backing provides dimensional stability to the carpet. The secondary backing also may be in the form of a preformed sheet polymer or copolymer. Suitable preformed sheet compositions include urethane polymers, polymers and copolymers of ethylene, propylene, isobutylene, polyvinylbutyral and polyvinylchloride. When a preformed sheet secondary backing is used, it may be prefoamed and then laminated onto the primary backing, or the composition may contain a thermally activatable blowing agent and may be foamed immediately prior to lamination or after lamination. Additionally, the secondary backing may exhibit thermoplastic adhesive properties of its own, and the secondary backing can be preheated prior to lamination to render the surface thereof adhesive. Alternatively, the secondary backing may comprise a hot melt, a liquid PVC plastisol, one or more fused PVB layer(s) or bitumen, often in conjunction with fiberglass scrim or other scrim known to provide dimensional stability.

In forming a non-tufted carpet, the carpet coating is generally thickened to a viscosity of about 25,000 to 75,000 cps and applied to a scrim surface. The fibers then are directly embedded into the wet coating using conventional techniques and then dried. Again, a secondary coating similar to that described above is desirably employed.

The coating is applied in a manner such that it penetrates the fibers of the carpet yarns to yield better adhesion, fiber bundle integrity, anti-fuzzing properties and suitable tuft-bind values. Suitable carpet performance properties can be achieved by applying an amount of the coating composition ranging from about 10 ounces per square yard to about 40 ounces per square yard (dry basis).

The following test procedures were used to evaluate carpet coating compositions of the present invention.

Carpet Testing Protocols

Carpet Coating Formulation

| | Wt % |
|---|---|
| Interpolymer (at 62% solids) | 58.0 |
| Dispersant (at 25% solids) | 0.4 |
| Calcium Carbonate Filler | 33.0 |
| Thickener (at 10% solids) | 2.3 |
| Froth Aid (at 30% solids) | 0.7 |
| Water | 4.5 |
| Total Compound Solids = | 69.5% |
| Brookfield Compound Viscosity = | 6,000-12,000 cps |
| (#4 or 5 Spindle/72 F/20 rpm) | |

Carpet Coating Procedure

Compounded samples were frothed in a lab foaming unit (Hobart mixer) to achieve foamed or frothed compounds with blow ratios of 1:3 to 3:1 (air to compound). The frothed compounds then were scrape-coated onto the back of tufted carpet. The tufted carpet had an uncoated weight 18 to 28 oz/yd². Once coated with the frothed compound, the carpet was dried at 130° C. for 8 minutes.

Add-on weights of dried precoat compound were in the range of 22 to 30 oz/yd². Precoated carpet samples were tested for adhesion to PVB. Adhesion to PVB was measured by testing the force needed to delaminate the precoated carpet from the preformed sheet of PVB to which it had been heat laminated.

Test Method for Delamination Values

PVB Adhesion

This test measures the PVB adhesion properties of the carpet coating by testing the force required to separate the precoated carpet from a sheet of preformed PVB to which has been previously heat laminated. The test was conducted by heating the carpet sample and the PVB sheet for 6 minutes at a temperature of 140-160 C. The heated PVB sheet in contact with the back of the carpet sample was put through a set of nip rollers with a ¼ inch gap. This was done to simulate the heat lamination process used in the carpet industry. The PVB sheet was then separated partially from the coated carpet sample and each component was placed in the either the top or bottom claps of an Instron. The clamps of the Instron were then separated at a rate of 12 inches per minute and the force required to separate the PVB backing from the precoated carpet was measured and recorded. The results were reported in pounds per 3 inch wide carpet strips.

### EXAMPLE 1

### Emulsion Binders (Interpolymers) were Prepared According to the Procedures Described Herein Below

A general procedure for the preparation of a vinyl acetate-ethylene copolymer emulsion of the invention is as follows:

The initial charge to the reactor includes the following:

| | |
|---|---|
| Water (deionized) | 1400.0 g |
| Ferrous sulfate (1% aq. sol'n) | 16.0 |
| PVOH LV (88% hyd.); 25% Aq. | 375.0 |
| Disodium ethoxylated alcohol half ester of | |
| sulfosuccinic acid, 31% Aq. | 155.0 |
| PVOH MV (92% hyd.); 10% Aq | 470.0 |
| PVOH LV (98% hyd.); 10% Aq | 235.0 |
| Fatty Alcohol (C12/14) Ethoxylate (30EO), 65% | 40.0 |
| Sodium bicarbonate | 0.9 |
| Versene 100 (1%) | 16.0 |
| Phosphoric acid | 1.5 |
| Sodium Form. Sulfoxylate | 2.0 |
| Vinyl acetate | 940.0 g |

Ethylene - amount to equilibrate reactor to 600 psi at 50° C.

Slow additions:

| | | |
|---|---|---|
| 1. | Vinyl acetate | 2445 g |
| 2. | Water | 250.0 |
| | t-butyl hydroperoxide (70% aq. sol'n) | 16.0 |
| 3. | Water (deionized) | 250.0 g |
| | Sod. Form. Sulfoxylate | 12.0 |
| | Sodium bicarbonate | 1.0 |

The pH of the initial aqueous charge was adjusted to 4.0-4.3 with the phosphoric acid.

A 10 L stainless steel pressure reactor was filled with initial aqueous mix. It was flushed with nitrogen. With the agitation at about 250 rpm, the vinyl acetate was added. After closing all reactor ports, it was purged twice with nitrogen (25 to 40 psi) and then with ethylene (50 psi). It was then heated to 5\tilde{0}C. Agitation was increased to 550 rpm and it was pressurized with ethylene to 600 psi. The reactor temperature and ethylene pressure were allowed to equilibrate for 15-20 minutes. The ethylene supply was then closed off. Agitation was reduced to 400 rpm.

The reaction was initiated by starting both slow-additions (no.2 and 3) at 2.5 hr. rates (80 cc/hr). After the initial temperature rise, about 2-\tilde{5}C, the jacket temperature and oxidizer rate (no.2) are adjusted to allow the temperature to reach 6\tilde{5}C in about 15 minutes. The slow addition, no.1, was started and added over 3.5 hrs. Ethylene was added to maintain a reactor pressure of 1100 psi for 2 hrs. During the run, the oxidizer and reducer rates are adjusted to maintain conversion rate with the reaction run at 65° C.-70. After the end of slow-add no.1, the reaction is continued until the residual vinyl acetate is reduced to 1.5-2.0% (about 0.5 hrs). It is then cooled to 4\tilde{5}C and transferred to the degassing tank to vent off residual ethylene pressure. 2 g of Defoamer, Colloid 681f (Allied Colloids), was added to the degassing tank followed by finishing redox initiator shots. This includes 15 g of a 6% t-BHP solution, waiting 5 minutes, then 15 g of a 6% SFS solution added over 15 minutes. This reduces the vinyl acetate to <0.3%. After cooling to 3\tilde{0}C, the pH is adjusted to 4-5 with 14% ammonium hydroxide.

| | |
|---|---|
| Solids, % | 63.0 |
| Viscosity (20 rpm, RVT#3) | 5000 cps |
| pH | 4.5 |
| % grit (200 mesh) | 0.020 |
| Tg, C. | −22° |

### EXAMPLE 2

The process of Ex.1 is repeated, but 47 g of acrylic acid(AA) is added to slow-add no.1 The reaction was run as in Ex. 1 at 68° C. and with a 4 hr slow-add of 1. (functional monomer) The final composition is 72VA/28 E/1 AA (Binder C)

The emulsion had the final properties:

| | |
|---|---|
| Solids, % | 63.0 |
| Viscosity (20 rpm, RVT#3) | 3800 cps |
| pH | 4.3 |
| % grit (200 mesh) | 0.020 |
| Tg, C. | −20° |

### EXAMPLE 3

The emulsion made as in Ex.2, with the level of functional monomer, acrylic acid, AA, increased to 94 g. The reaction was run the same as in Ex.2. The final emulsion had the following properties: The composition is 72VA/28 E/2 AA (Binder D)

| | |
|---|---|
| Solids, % | 62.0 |
| Viscosity (20 rpm, RVT#3) | 1610 cps |
| pH | 4.5 |
| % grit (200 mesh) | 0.025 |
| Tg, C. | −16° |

Similarly, compositions were made with intermediate acrylic acid levels as follows:
Binder B: 72VA/28E/0.5AA
E: 72VA/28E/2.5AA
F: 72VA/28E/3AA

### EXAMPLE 4

The emulsion made as in Ex.2, with the functional monomer changed to hydroxypropyl acrylate (H PA) at 47 g.

The reaction was run the same as in Ex.2. The final emulsion had the following properties: Binder G: 72VA/28E/1 HPA

| | |
|---|---|
| Solids, % | 62.3 |
| Viscosity (20 rpm, RVT#3) | 4470 cps |
| pH | 4.6 |
| % grit (200 mesh) | 0.020 |
| Tg, C. | −15° |

### EXAMPLE 5

Ex. 4 with the functional changed to acrylamide (AM) slow added at 47 g. The final emulsion had the following properties: Binder H:

72VA/28E/1AM

| | |
|---|---|
| Solids, % | 62.4 |
| Viscosity (20 rpm, RVT#3) | 4350 cps |
| pH | 4.6 |
| % grit (200 mesh) | 0.010 |
| Tg, C. | −20° |

### EXAMPLE 6

Ex. 4 with NVF (N-vinyl formamide) used as the functional monomer; slow-added at 47 g. The final emulsion had the following properties: Binder I:

72VA/28E/1 NVF

| | |
|---|---|
| Solids, % | 62.1 |
| Viscosity (20 rpm, RVT#3) | 4610 cps |
| pH | 4.6 |
| % grit (200 mesh) | 0.012 |
| Tg, C. | −20° C. |

### EXAMPLE 7

Emulsion binders were prepared according to the procedures described herein above. Monomer composition of the control and the seven other binders prepared are set forth in Table 1.

TABLE 1

| Binder | VA | E | PVOH | S¹ | AA² | Avg³ |
|---|---|---|---|---|---|---|
| Control⁵ | 80 | 20 | 3.5 | x | 0 | 7 |
| Control⁶ | 84 | 16 | 4.2 | X | 3 | 9 |
| A | 72 | 28 | 3.5 | 1.1 | 0 | 12 |
| B | 72 | 28 | 3.5 | 1.1 | 0.5 | 16 |
| C | 72 | 28 | 3.5 | 1.1 | 1.0 | 17 |
| D | 72 | 28 | 3.5 | 1.1 | 2.0 | 19 |
| E | 72 | 28 | 3.5 | 1.1 | 2.5 | 22 |
| F | 72 | 28 | 3.5 | 1.1 | 3.0 | 22 |

¹S = Surfactant(anionic)
²AA = Acrylic Acid
³Avg = Delamination Average Load (lbs)
⁵Commercial PVOH stabilized EVA adhesive base

TABLE 2

| | Functional | |
|---|---|---|
| Binder | Monomer | Avg |
| G | 1 HPA | 11 |
| H | 1 AM | 10 |
| I | 1 NVF | 12 |

1 HPA = 1 wt % hydroxypropyl acrylate
1 AM = 1 wt % acrylamide
1 NVF = 1 wt % N-vinyl formamide

While acrylic acid is the preferred functional monomer, other functional monomers may also be utilized as shown in Table 2.

As the data indicate, the use of the functional monomer in preparation of the emulsion binder, even at low levels, significantly increases adhesion of the carpet coating to PVB substrates when compared to coatings prepared from binders which were not prepared with no functional monomer. Table I shows that increasing the level of functional monomers increases the adhesion of the coating to the PVB secondary backing.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

1. A carpet coating composition, comprising:
a) an interpolymer having a Tg in the range of about 0 to about −40° C. present in amounts effective to function as a binder in the carpet coating composition, said interpolymer prepared by the emulsion polymerization of
one or more vinyl ester monomers;
ethylene;
from about 1 pphm to 10 pphm of at least one functional monomer;
water;
stabilizing system comprising polyvinyl alcohol and one or more surfactants; and
optionally, one or more comonomers or multi-functional comonomers.

2. The composition of claim 1 wherein the interpolymer is prepared by emulsion polymerization of from about 60 pphm to about 80 pphm of the vinyl ester monomer, from about 20 pphm to about 40 pphm of ethylene and from about 1 pphm to 10 pphm of the functional monomer.

3. The composition of claim 1 wherein the polymer is prepared by emulsion polymerization of from about 70 pphm to about 80 pphm of the vinyl ester monomer, from about 20 pphm to about 30 pphm of ethylene and about 1 pphm to about 7 pphm of the functional monomer.

4. The composition of claim 1 wherein the vinyl ester monomer is selected from the group consisting of esters of alkanoic acids, the acids having from one to about 13 carbon atoms, and the functional monomer is selected from the group consisting of acrylic and methacrylic acid or the half esters of maleic acid such as monoethyl, monobutyl or monooctyl maleate, beta carboxy ethyl acrylate, acrylamide, N,N-dimethyl acrylamide, hydroxy alkyl acrylate, hydroxyl alkyl methacrylate, N-methylol (meth)acrylamide, N-vinylpyrrolidinone, N-vinyl formamide, and mixtures thereof.

5. The composition of claim 1 wherein the vinyl ester is vinyl acetate and the functional monomer is selected from the group consisting of acrylic and methacrylic acid or the half esters of maleic acid such as monoethyl, monobutyl or monooctyl maleate, beta carboxy ethyl acrylate, acrylamide, N,N-dimethyl acrylamide, hydroxy alkyl acrylate, hydroxyl alkyl methacrylate, N-methylol (meth)acrylamide, N-vinylpyrrolidinone, N-vinyl formamide, and mixtures thereof.

6. The composition of claim 1, wherein the functional monomer is acrylic acid.

7. The composition of claim 1 further comprising one or more ingredients selected from the group consisting of a filler, a thickener, a defoamer, a frothing agent and a dispersant, in amounts effective to perform their respective intended function.

8. The composition of claim 1 wherein the composition provides a delamination average load of at least 10 lbs on a polyvinylbutyral substrate.

9. The composition of claim 1 wherein the optional one or more comonomers are selected from the group consisting of acrylates and maleates.

10. The composition of claim 9, wherein the optional one or more comonomers are selected from the group consisting methyl acrylate, ethyl acrylate, butyl acrylate, 2-ethyl hexyl acrylate and mixtures thereof.

11. The composition of claim 1 wherein the optional multifunctional co-monomers are selected from the group consisting of diallyl adipate, triallyl cyanurate, butanediol diacrylate, allyl methacrylate and mixtures thereof.

12. An carpet product, comprising
a carpet backing or substrate,
carpet fibers; and
a carpet coating composition which comprises
(a) an interpolymer present in amounts effective to function as a binder in the carpet coating composition, said interpolymer prepared by the emulsion polymerization of
one or more vinyl ester monomers;
ethylene; and
from about 1 pphm to 10 pphm of at least one functional monomer,
(b) water; and
(c) an emulsifier comprising polyvinyl alcohol and one or more surfactants present in amounts effective to disperse the polymer in the water, wherein the carpet backing or substrate has applied thereto an amount of the carpet coating composition which is effective to secure the carpet fibers to a polyvinylbutyral carpet backing or polyvinylbutyral substrate.

13. The carpet product of claim 12 wherein the interpolymer is prepared by emulsion polymerization of from about 60 pphm to about 80 pphm of the vinyl ester monomer, from about 20 pphm to about 40 pphm of ethylene; and from about 1 to 10 pphm of the functional monomer.

14. The carpet product of claim 12 wherein the polymer is prepared by emulsion polymerization of from about 70 pphm to about 80 pphm of the vinyl ester monomer, from about 20 pphm to about 30 pphm of ethylene; and about 1 pphm to about 7 pphm of the functional monomer.

15. The carpet product of claim 12 wherein the vinyl ester monomer is selected from the group consisting of esters of alkanoic acids, the acids having from one to about 13 carbon atoms, and the functional monomer is selected from the group consisting of acrylic and methacrylic acid or the half esters of maleic acid such as monoethyl, monobutyl or monooctyl maleate, beta carboxy ethyl acrylate, acrylamide, N,N-dimethyl acrylamide, hydroxy alkyl acrylate, hydroxyl alkyl methacrylate, N-vinyl formamide, and mixtures thereof.

16. The carpet product of claim 12 wherein the vinyl ester is vinyl acetate and the functional monomer is selected from the group consisting of acrylic and methacrylic acid or the half esters of maleic acid such as monoethyl, monobutyl or monooctyl maleate, beta carboxy ethyl acrylate, acrylamide, N,N-dimethyl acrylamide, hydroxy alkyl acrylate, hydroxyl alkyl methacrylate, N-vinyl formamide, and mixtures thereof.

17. The carpet product of claim 10 wherein the carpet coating composition further comprises one or more ingredients selected from the group consisting of a filler, a thickener, a defoamer, a frothing agent and a dispersant, in amounts effective to perform their respective intended function.

18. The carpet product of claim 12, wherein the carpet coating composition provides a delamination load of at least 10 lbs on a polyvinylbutyral substrate.
